(19) United States
(12) Patent Application Publication
(10) Pub. No.: US 2011/0081479 A1
(43) Pub. Date: Apr. 7, 2011

(54) Seal coating machine and method

(76) Inventor: Allen D. Morris, JR., Bridgeton, NJ (US)

(21) Appl. No.: 12/807,983

(22) Filed: Sep. 17, 2010

Related U.S. Application Data
(60) Provisional application No. 61/249,554, filed on Oct. 7, 2009.

(51) Int. Cl. B05D 1/02; B05C 11/04

(52) U.S. Cl. 427/136; 118/100

(57) ABSTRACT

A seal coating machine and method utilizes a handle member upstanding from the front end of an enclosed housing having an open bottom. The handle member has a through channel for directing the flow of seal coating material from the handle and into the housing. One or more nozzles connected to the handle spray seal coating material into the housing and down onto asphalt pavement surfaces. As the handle of the seal coating material is pulled forward, a squeegee at the rear of the housing pushes down on and smoothes the seal coating material onto the pavement surfaces and lateral guide elements on the housing frame the edges of the applied seal coating material which is being expelled into the housing, thus ensuring that, as the seal coating machine is pulled forward, a straight line of the material is always produced along the sides of the housing.

### RELATED APPLICATION

The herein application claims the benefit of provisional application Ser. No. 61/249,554, filed on Oct. 7, 2009.

### BACKGROUND OF THE INVENTION

Asphalt or concrete pavement, such as is found on driveways, parking lots, and other road surfaces, is continuously being detrimentally effected by weather, chemicals and constant vehicle traffic. Over time, heat, moisture, pressure, and chemical reactions from these sources attack the binder material in the asphalt or concrete pavement, eventually weakening it and destroying its flexibility. Gasoline, oil, and other oil and chemical based fluid spillages also adversely effect the binder material. As the asphalt binder becomes weaker and loses its flexibility, the aggregate stone in the asphalt becomes loose, thus permitting water to penetrate deeper into the surface. This further accelerates binder deterioration. Cracks and potholes will then form as vehicle traffic wears on these asphalt pavement weaknesses. Major repairs or an entirely new layer of asphalt is eventually required. However, if the asphalt binder can be protected and its integrity maintained, the effective overall life of the asphalt pavement can be extended.

The industry commonly uses a seal coating material, generally formed of a coal-tar emulsion, which is applied on top of newly paved asphalt surfaces. The seal coating material beautifies, preserves, and protects the asphalt pavement from deterioration, primarily because it protects the binder within the asphalt itself.

In sealing asphalt pavement surfaces, it is common practice to apply the seal coating material, in liquid form, to the asphalt surface, uniformly spreading the material on the surface. Seal coating material is most often spread on asphalt pavement surfaces by brush and then squeegeed to provide penetration of the surface interstices and to form a uniform coating. In the case of smaller areas, such as driveways, the seal coating material is normally applied by hand, with the material being dispensed from a container and the operator manually utilizing brushes and squeegees to spread the material. For larger asphalt paved areas, asphalt seal coating machines are used to dispense seal coating material, normally from a tank. Such a machine is equipped with a squeegee to provide an even spreading of the material and a final finish on the surface being sealed.

However, regardless of the manner in which the seal coating material is applied, it is most difficult, if not virtually impossible, to easily, cleanly, and precisely apply a neat, straight line of seal coat material along edges of pavement surfaces and between road pavement surfaces and curbs. Prior and current means of applying seal coating material, whether manually or by machine, usually result in unwanted overspray of the material over and above the paved asphalt surfaces, onto concrete walls, vertical curbs, borders, or on grass adjacent to driveways. There is no machine and no method of applying seal coating material which guarantees straight application of material along edges and borders and accomplishes this objective at the walking speed of the operator/applicator.

### SUMMARY OF THE INVENTION

It is thus the object of the present invention to overcome the disadvantages and limitations of previous seal coat material machines and seal coating material methods.

It is the object of the present invention to provide a seal coating machine particularly adapted for spreading seal coating material on driveways, parking lots, road surfaces, driveway aprons, and the like in a neat and efficient manner.

It is a further object of the present invention to provide a seal coating machine and method which applies seal coating material in a straight line along concrete walls, driveway edges, and similar borders.

It is another object of the present invention to provide a seal coating machine and method which applies seal coating material only on desired asphalt pavement and not on surfaces on vertical concrete walls, curbs, grass, or outside borders.

It is still another object of the present invention to provide a seal coating machine and method which accomplishes the objective of neatly and efficiently applying seal coating material along asphalt pavement edges, and does so at the walking speed of the operator.

These and other objectives are accomplished by the present invention, a seal coating machine and method which utilizes a handle member upstanding from the front end of an enclosed housing having an open bottom. The handle member has a through channel for directing the flow of seal coating material from the handle and into the housing. One or more nozzles connected to the handle spray seal coating material into the housing and down onto asphalt pavement surfaces. As the handle of the seal coating material is pulled forward, a squeegee at the rear of the housing pushes down on and smoothes the seal coating material onto the pavement surfaces and lateral guide elements on the housing frame the edges of the applied seal coating material which is being expelled into the housing, thus ensuring that, as the seal coating machine is pulled forward, a straight line of the material is always produced along the sides of the housing. The machine and manner of its operation is exhibited at www.twisben.com.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an isometric front view of the seal coating machine of the present invention.

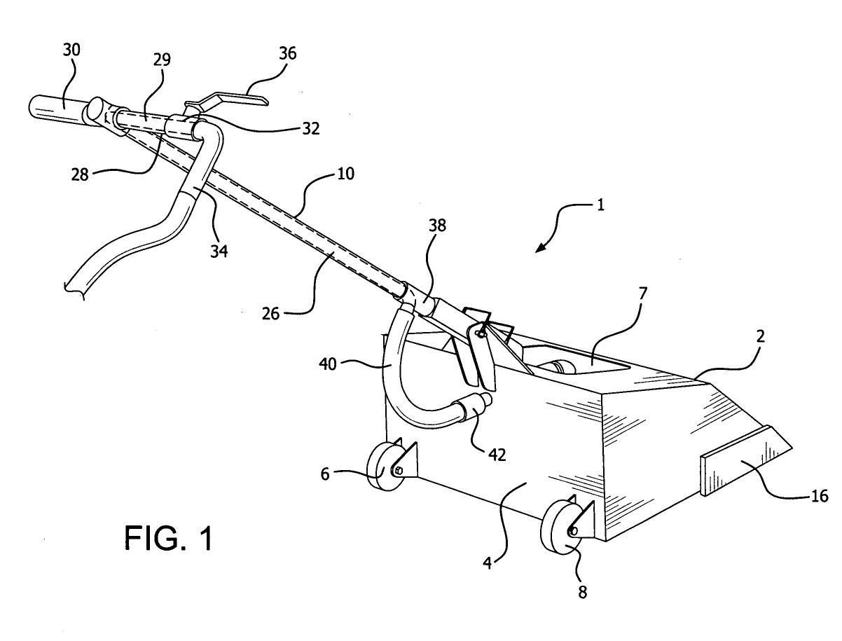

FIG. 2 is an isometric view of the underside of the seal coating machine of the present invention.

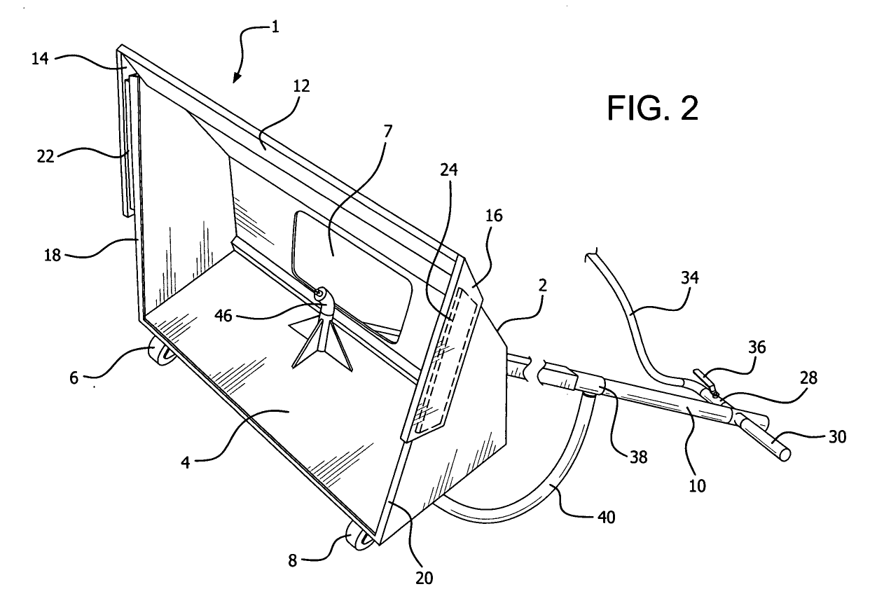

FIG. 3 is a cross-sectional view showing the operation of the seal coating machine of the present invention.

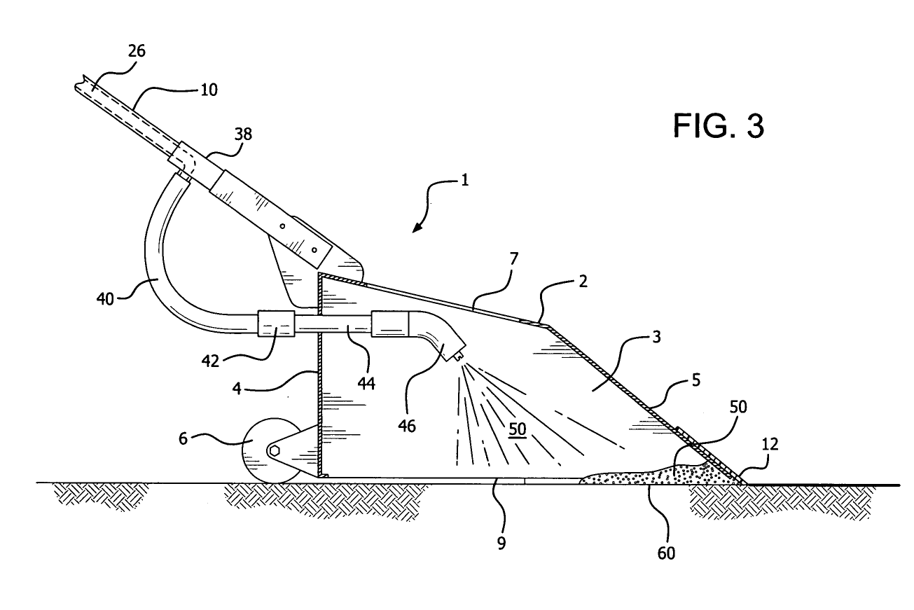

FIG. 4 is a view of the seal coating machine of the present invention being used to apply seal coating material to an asphalt pavement surface.

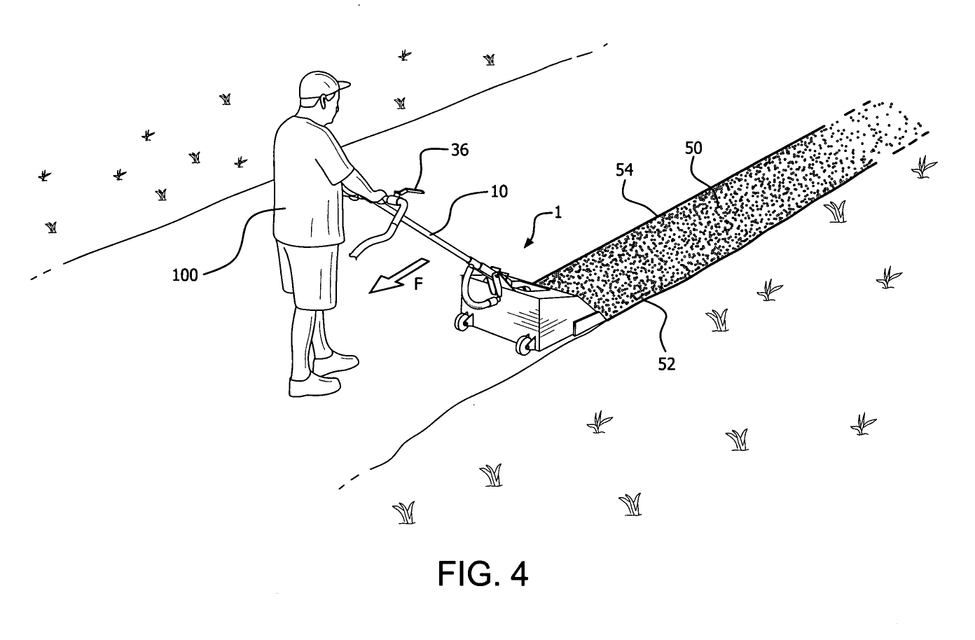

### DETAILED DESCRIPTION OF THE INVENTION

Seal coating machine 1 of the present invention comprises enclosed housing 2 having internal space 3, front wall 4, back wall 5, and top access opening 7. Bottom 9 of housing 2 is completely open. Wheels 6 and 8 are located at the front of housing 2, which is designed to be pulled forward F by means of handle member 10, upstanding from the front end of the housing. Squeegee element 12 is located at the rear of housing 2. Squeegee element 12 traverses the full width of housing 2.

Lateral housing guide elements 14 and 16 extend from squeegee element 12, partially along the sides and below bottom surfaces 18 and 20 of housing 2. Squeegee element 12 and guide elements 14 and 16 surround the bottom rear portion of housing 2. Elongated cut-in sections 22 and 24 extend between guide element 14 and bottom surface 18, and guide element 16 and bottom surface 20.

Through channel 26 extends substantially the full length of handle member 10. Handholds 28 and 30 are located at the uppermost end of handle member 10. Handhold 28 is hollow, and has a short through passage 29. At its inboard end, passage 29 of handhold 28 opens to channel 26 within handle member 10. The outboard end of handhold 28 is also open and comprises connector fitting 32, configured to be attached to seal coating material hose 34. Control valve 36 is provided on handhold 28 to open and close passage 29 within the handhold.

Fitting 38, extending from the lower end of handle member 10, is open to channel 26, which terminates just above this fitting. Connector hose 40 is attached at one end to fitting 38 and at its other end to fitting 42. Fitting 42 is configured to be connected to pipe section 44 which extends through front wall 4 of housing 2, into internal space 3 of the housing. Discharge nozzle 46 is connected to the end of pipe section 44, within housing 2. More than one nozzle can be utilized to disburse seal coating material.

In operation, seal coating material 50 is pumped to handhold 28. Control valve 36 is open to allow the flow of seal coating material 50 through handhold 28, down channel 26 within handle member 10, through connector hose 40 and pipe section 44; and then to nozzle 46, where the seal coating material is discharged into internal space 3 of housing 2 and onto ground surface 60.

As seal coating material 50 accumulates within and on ground surface 60, operator 100 pulls handle member 10 of seal coating machine 1 forward F, via handholds 28 and 30, thus moving the housing in a forward direction. This forward motion results in squeegee element 12 pushing down on and smoothing seal coating material 50 on ground surface 60. Significantly, the forward motion of seal coating machine 1 causes cut-in sections 22 and 24 of lateral housing guide elements 14 and 16, respectively, to frame the edges of seal coating material 50 being expelled into internal space 3 of housing 2, ensuring that straight lines of the seal coating material 52 and 54 are always produced along the sides of the housing. When areas of the ground surface do not require the spreading of the seal coating material, control valve 36 is closed to stop the flow of seal coating material 50 through handle member 12 and thus to housing 2.

Use of the seal coating machine 1 of the present invention will ensure that seal coating will always be spread on pavement or other ground surfaces in an even, smooth manner, and with neatly trimmed and framed, straight edges.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A seal coating machine manually moveable along the surface of ground to which seal coating material is being applied, said seal coating machine comprising:
a handle member upstanding from the front of an enclosed housing, said handle member having means for directing the flow of seal coating material into the housing;
discharge means within the housing for delivering seal coating material from the handle member to said surface of the ground;
squeegee means located at the rear of the housing for smoothing the seal coating material delivered by the discharge means onto said surface of the ground, during forward movement of the seal coating machine along the surface of the ground; and
lateral housing guide means for producing substantially straight lines of seal coating material along the sides of the housing during forward movement of the seal coating machine along said surface of the ground.

2. The seal coating machine as in claim 1 wherein the directing means comprises a channel through the handle member.

3. The seal coating machine as in claim 2 further comprising means on the handle member for controlling the flow of seal coating material to the housing.

4. The seal coating machine as in claim 1 wherein the discharge means comprises at least one nozzle.

5. The seal coating machine as in claim 1 wherein the lateral housing guide means comprises two guide elements located at the rear of the housing, each guide element extending along a side and below the bottom of the housing.

6. The seal coating machine as in claim 1 further comprising wheels located at the front of the housing.

7. The seal coating machine as in claim 1 further comprising an access opening at the top of the housing.

8. The seal coating machine as in claim 1 wherein the bottom of the housing is open.

9. A seal coating machine manually moveable along the surface of ground to which seal coating material is being applied, said seal coating machine comprising:
a handle member extending from the front of an enclosed housing having an open bottom, said handle member having means for directing the flow of seal coating material into the housing, said directing means comprising a channel through the handle member;
discharge means within the housing for delivering seal coating material from the handle member to said surface of the ground;
squeegee means located at the rear of the housing for smoothing the seal coating material delivered by the discharge means on said surface of the ground, during forward movement of the seal coating machine along the surface of the ground;
wheels located at the front of the housing; and
lateral housing guide means for producing substantially straight lines of seal coating material along the sides of the housing during forward movement of the seal coating machine along said surface of the ground, the lateral guide means comprising two guide elements located at the rear of the housing, each guide element extending along a side and below the bottom of the housing.

10. The seal coating machine as in claim 9 further comprising means on the handle member for controlling the flow of seal coating material to the housing.

11. The seal coating machine as in claim 9 wherein the discharge means comprises at least one nozzle.

12. The seal coating machine as in claim 9 further comprising an access opening at the top of the housing.

13. A method of applying seal coating material to the surface of the ground, comprising the steps of:
providing a seal coating machine having a handle member upstanding from an enclosed housing;
directing the flow of seal coating material through the handle member and towards the housing;
discharging the flow of seal coating material from the handle member into the housing;
pulling the handle member and thus the housing in a forward direction;
expelling seal coating material from the housing onto the surface of the ground;
smoothing the expelled seal coating material onto the surface of the ground upon the forward motion of the housing; and
framing the edges of the expelled seal coating material so as to ensure that straight lines of seal coating material are produced along the sides of the housing as the handle member and housing are pulled in the forward direction.

14. The method as in claim 13 wherein a squeegee is provided for smoothing the expelled seal coating material onto the surface of the ground.

15. The method as in claim 13 wherein lateral guide elements are provided at the rear of the housing, each guide element extending along a side and below the bottom of the housing, to trim the edges of the expelled seal coating material.
